(19) United States
(12) Patent Application Publication
(10) Pub. No.: US 2008/0316562 A1
(43) Pub. Date: Dec. 25, 2008

(54) Mems Scanner System and Method

(75) Inventors: Renatus H. M. Sanders, Roermond (NL); Alexander J. A. C. Dorrestein, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 12/097,600

(22) PCT Filed: Dec. 8, 2006
(86) PCT No.: PCT/IB06/54712

§ 371 Date: Jun. 16, 2008

Related U.S. Application Data
(60) Provisional application No. 60/750,751, filed on Dec. 15, 2005.

(51) Int. Cl. G02B 26/10

(52) U.S. Cl. 359/212

(57) ABSTRACT

A MEMS scanner system and method, the system for deflecting an incident laser beam including a MEMS mirror 26 operable to receive the incident laser beam and to generate a reflected laser beam, and an opaque plate 28 having an aperture 30, the opaque plate 28 being opposite the MEMS mirror 26. The aperture 30 is sized to permit the incident laser beam and the reflected laser beam to pass through the aperture 30.

This invention relates generally to scanner systems, and more specifically to MEMS scanner systems and methods.

Micromachined Electrical Mechanical System (MEMS) scanners employ a MEMS mirror to deflect laser beams incident on the MEMS mirror. The MEMS mirror pivots on one or two axes in response to control signals, so that the incident laser beam is deflected as desired. The reflected laser beam can be projected on a screen, on a light sensor, or into a viewer's eye. Examples of uses for MEMS scanners include head-up displays, handheld projection devices, laser based projection devices, flexible lithography, and the like. The MEMS scanners can include optical elements, such as mirrors, dichroic mirrors, lenses, gratings, and the like, as required to process the incident laser beam and the reflected laser beam.

The MEMS scanners of the current generation are fragile, although not as fragile as the first generation devices. Shielding is required to protect the MEMS mirror from impact damage and/or from outside forces which could influence its operation. Presently, a glass plate is provided in front of the MEMS mirror to protect it from outside objects. Both the incident laser beam and the reflected laser beam pass through the glass plate. Although providing protection, the cover plate creates additional problems. Stray light reflected from or reflected within the glass plate accompanies the reflected laser beam to the screen or light sensor. The stray light appears in images as a bright spot for a one-dimensional MEMS scanner or as a bright line for a two-dimensional MEMS scanner. Attempts have been made to solve this problem by providing the glass plate with an anti-reflective coating, but the attempts have been unsuccessful.

Another attempted solution to the problem of stray light has been to remove the cover plate and leave the MEMS mirror unprotected. This solves the problem of stray light being reflected by the cover plate, but gives rise to additional problems. Other stray light can occur from several sources: the optical elements processing the incident laser beam can generate stray light; the optical elements, such as dichroic mirrors, which process the reflected laser beam can generate stray light; and the light leakage into the MEMS scanner, can generate stray light. The stray light reflects from the MEMS mirror or other internal surfaces, such as the highly reflective silicon surfaces around the MEMS mirror, and can accompany the reflected laser beam to the screen or light sensor. Concentrated stray light produces spots or lines on images. Generalized stray light reduces contrast by decreasing the light difference between the reflected laser beam and the background. Any stray light decreases the quality of the image and desirability of the device in which the MEMS scanner is used.

It would be desirable to have a MEMS scanner system and method that overcomes the above disadvantages.

One aspect of the present invention provides a MEMS scanner system for deflecting an incident laser beam including a MEMS mirror operable to receive the incident laser beam and to generate a reflected laser beam, and an opaque plate having an aperture, the opaque plate being opposite the MEMS mirror. The aperture is sized to permit the incident laser beam and the reflected laser beam to pass through the aperture.

Another aspect of the present invention provides a method for reducing stray light in a MEMS scanner including providing a MEMS mirror, mounting an opaque plate having an aperture across from the MEMS mirror, and directing an incident laser beam through the aperture onto the MEMS mirror to reflect from the MEMS mirror through the aperture as a reflected laser beam.

Another aspect of the present invention provides a system for reducing stray light in a MEMS scanner including a MEMS mirror, means for mounting an opaque plate having an aperture across from the MEMS mirror, and means for directing an incident laser beam through the aperture onto the MEMS mirror to reflect from the MEMS mirror through the aperture as a reflected laser beam.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

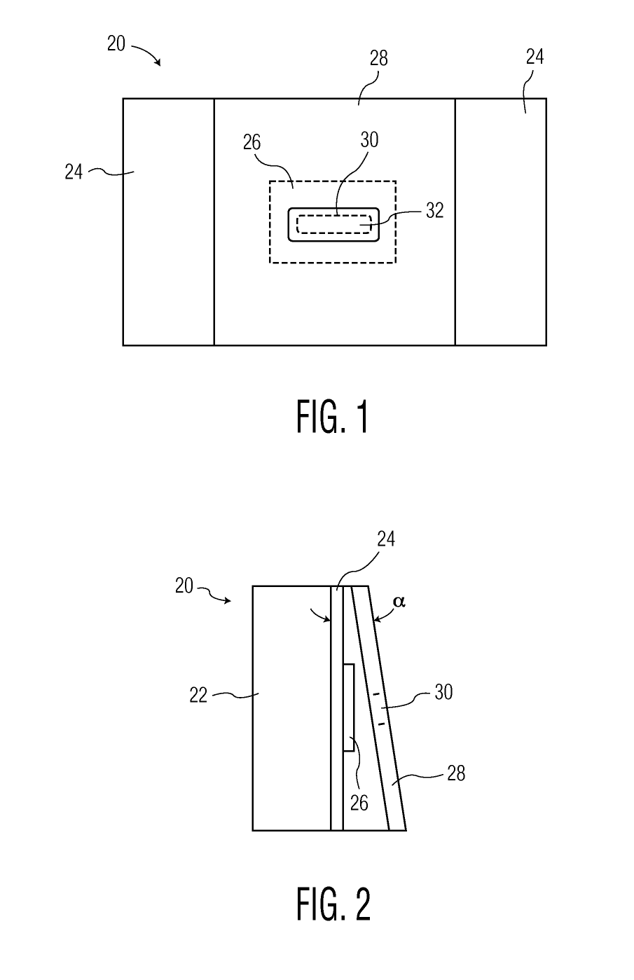

FIGS. 1 & 2 are front and side views, respectively, of a MEMS scanner system made in accordance with the present invention;

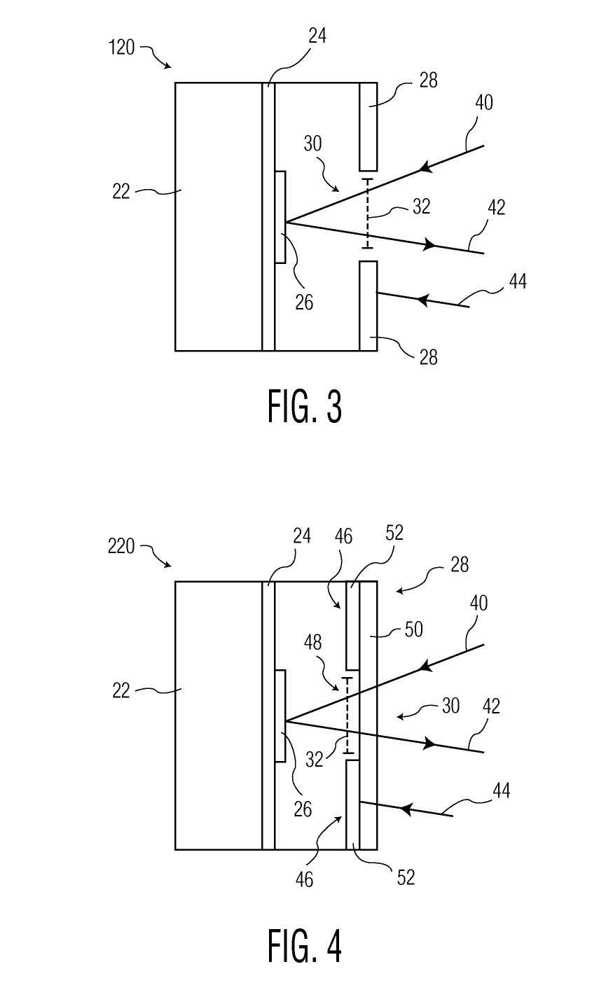

FIG. 3 is a cross section view of a MEMS scanner system made in accordance with the present invention;

FIG. 4 is a cross section view of another MEMS scanner system made in accordance with the present invention; and

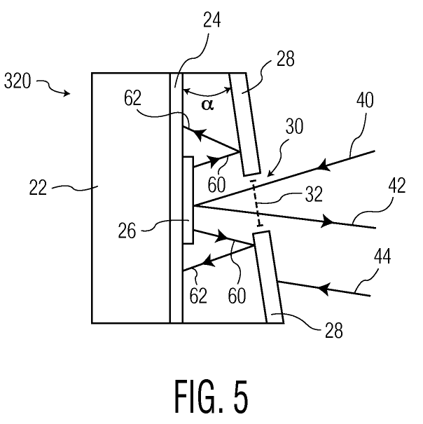

FIG. 5 is a cross section view of another MEMS scanner system made in accordance with the present invention.

FIGS. 1 & 2, in which like elements share like reference numbers, are front and side views, respectively, of a MEMS scanner system made in accordance with the present invention. The MEMS scanner system uses an aperture in an opaque plate to reduce the amount of stray light reaching the MEMS mirror. Stray light can be generated by the laser source and optical elements providing the incident laser beam, by the receiving component and optical elements receiving the reflected laser beam, and/or by other incidental light sources. Examples of receiving components include screens, light sensors, viewers' eyes, and the like. Examples of optical elements include mirrors, dichroic mirrors, lenses, gratings, and the like.

Referring to FIGS. 1 & 2, MEMS scanner system 20 includes a MEMS mirror 26 and an opaque plate 28 opposite the MEMS mirror 26. The opaque plate 28 has an aperture 30. The MEMS mirror 26 is mounted on a body 22 having a MEMS mirror plane 24 and is operable to receive an incident laser beam (not shown) entering through the aperture 30 and to generate a reflected laser beam (not shown) exiting through the aperture 30. The aperture 30 is sized to permit the incident laser beam and the reflected laser beam to pass through the aperture 30. The direction of the reflected laser beam is determined by a control signal (not shown) to the MEMS mirror 26. The incident laser beam and the reflected laser beam define a travel region 32 within the aperture 30. The travel region 32 is the area of travel of the incident laser beam and the reflected laser beam over the aperture 30. The opaque plate 28 is mounted at a mounting angle α with respect to the MEMS mirror plane 24.

The MEMS mirror 26 can be any MEMS mirror responsive to a control signal to deflect a laser beam. In one embodiment, the MEMS mirror 26 is a one dimensional MEMS mirror which deflects the laser beam along one axis. In another embodiment, the MEMS mirror 26 is a two dimensional MEMS mirror which deflects the laser beam along two axes. Exemplary MEMS mirrors are available from the Fraunhofer Institute for Silicon Technology (ISIT), Itzehoe, Germany, and the Fraunhofer Institute for Photonic Microsystems (IPMS), Dresden, Germany. The MEMS mirror 26 can be mounted behind, flush with, or proud of the MEMS mirror plane 24 of the body 22.

The opaque plate 28 can be any opaque plate having an aperture 30. The aperture 30 is as small as possible to so that the incident laser beam and the reflected laser beam can pass through the aperture 30, but a minimum of stray light can pass through. The aperture 30 can be large enough to avoid interference with the edges of the aperture 30. In one embodiment, the incident laser beam and the reflected laser beam define a travel region 32 within the aperture 30 and the aperture 30 is sized to accommodate the travel region 32 alone. In another embodiment, the aperture 30 is sized to accommodate the travel region 32 plus a predetermined distance suitable for the particular application. In one example, the aperture 30 extends a predetermined distance of about 1 to 5 millimeters outside the travel region 32. In one embodiment, the opaque plate 28 is made of an opaque material and the aperture 30 is a hole in the opaque material. In another embodiment, the opaque plate 28 is made of a plate of light transmitting material, such as transparent or translucent glass, with a coating applied to make the plate opaque. An uncoated portion forms the aperture. The aperture 30 can have a shape depending on the particular application, such as rectangular, square, rounded rectangular, stadium-shaped, and the like, as suited to the path of the incident laser beam and the reflected laser beam. The opaque plate 28 can be thin to avoid reflection from the edge of the aperture 30, but can be as thick as desired for a particular application. In one embodiment, the opaque plate 28 has an absorbing layer, such as carbon black or the like, to reduce reflection between the opaque plate 28, the MEMS mirror 26, and the body 22. Those skilled in the art will appreciate that the opaque plate 28 can have different shapes, materials, and apertures as suited to a particular application.

The opaque plate 28 is mounted at a mounting angle a with respect to the MEMS mirror plane 24. In one embodiment, the mounting angle α can be between about −10 and +10 degrees, and more particularly between about −5 and +5 degrees. Non-zero angles of the mounting angle α have the advantage of causing multiple reflections of stray light between the opaque plate 28 and the MEMS mirror plane 24 of the body 22. Because some stray light is lost with each reflection, the multiple reflections cause the stray light to fade out, so that the stray light stays in the wedge shaped space between the opaque plate 28 and the MEMS mirror plane 24 and does not exit the aperture 30. Non-zero angles of the mounting angle α can be any non-zero angle forming a wedge shaped space between the opaque plate 28 and the MEMS mirror plane 24. In one example, the mounting angle α is about 5 degrees. In one embodiment, the opaque plate 28 and/or the MEMS mirror plane 24 can have an absorbing layer, such as carbon black or the like, to further reduce internal reflection. In one embodiment, the opaque plate 28 can be mounted so that the distance between the aperture 30 and the MEMS mirror 26 is about 1 to 5 millimeters. Those skilled in the art will appreciate that the distance between the aperture 30 and the MEMS mirror 26 can be larger or smaller than about 1 to 5 millimeters as suited to a particular application.

FIG. 3, in which like elements share like reference numbers with FIGS. 1 & 2, is a cross section view of a MEMS scanner system made in accordance with the present invention. In this embodiment, the opaque plate 28 is made of an opaque material and the aperture 30 is a hole in the opaque material. Incident laser beam 40 from a laser source (not shown) enters the MEMS scanner system 120 through the travel region 32 of the aperture 30. The incident laser beam 40 reflects from the MEMS mirror 26 as reflected laser beam 42. The reflected laser beam 42 exits the MEMS scanner system 120 through the travel region 32 of the aperture 30. The reflected laser beam 42 can be projected on a screen, on a light sensor, or into a viewer's eye. Stray light 44, such as stray light reflected by the screen, random stray light, or the like, is blocked from the MEMS mirror 26 by the opaque material portion of the opaque plate 28.

FIG. 4, in which like elements share like reference numbers with FIG. 3, is a cross section view of another MEMS scanner system made in accordance with the present invention. In this embodiment, the opaque plate 28 has a coated portion 46 and an uncoated portion 48. The opaque plate 28 is made of a plate 50 of light transmitting material, such as transparent or translucent glass, with a coating 52 applied to make the coated portion 46 of the plate 50 opaque. The uncoated portion 48 of the plate 50 forms the aperture 30. Examples of coating materials include aluminum, chromium, silver, and the like. Incident laser beam 40 from a laser source (not shown) enters the MEMS scanner system 220 through the travel region 32 of the aperture 30. The incident laser beam 40 reflects from the MEMS mirror 26 as reflected laser beam 42. The reflected laser beam 42 exits the MEMS scanner system 220 through the travel region 32 of the aperture 30. The reflected laser beam 42 can be projected on a screen, on a light sensor, or into a viewer's eye. Stray light 44, such as stray light reflected by the screen, random stray light, or the like, is blocked from the MEMS mirror 26 by the coated portion 46 of the opaque plate 28. In another embodiment, the coating can be applied to both sides of the plate 50.

FIG. 5, in which like elements share like reference numbers with FIGS. 1-3, is a cross section view of another MEMS scanner system made in accordance with the present invention. In this embodiment, the opaque plate 28 is mounted at a mounting angle α with respect to the MEMS mirror plane 24 in the MEMS scanner system 320. FIG. 5 illustrates that a non-zero mounting angle for the mounting angle α reduces the amount of internally generated stray light that strikes the MEMS mirror 26. Stray light 60 originating at or near the MEMS mirror 26 reflects from the opaque plate 28 so that the reflected stray light 62 misses the MEMS mirror 26. The stray light can reflect multiple times between the opaque plate 28 and the MEMS mirror plane 24 without leaving the MEMS scanner system 320 through the aperture 30.

While the embodiments of the invention disclosed herein are presently considered to be preferred, various changes and modifications can be made without departing from the scope of the invention. The scope of the invention is indicated in the appended claims, and all changes that come within the meaning and range of equivalents are intended to be embraced therein.

1. A Micromachined Electrical Mechanical System (MEMS) scanner system for deflecting an incident laser beam comprising:
a MEMS mirror 26, the MEMS mirror 26 being operable to receive the incident laser beam and to generate a reflected laser beam; and
an opaque plate 28 having an aperture 30, the opaque plate 28 being opposite the MEMS mirror 26;
wherein the aperture 30 is sized to permit the incident laser beam and the reflected laser beam to pass through the aperture 30.

2. The system of claim 1 wherein the MEMS mirror 26 is mounted in a MEMS mirror plane 24 and the opaque plate 28 is angled with respect to the MEMS mirror plane 24.

3. The system of claim 1 wherein the opaque plate 28 has a mounting angle between about −10 and +10 degrees with respect to the MEMS mirror plane 24.

4. The system of claim 1 wherein the MEMS mirror plane 24 has an absorbing layer.

5. The system of claim 1 wherein the opaque plate 28 is made of an opaque material and the aperture 30 is a hole.

6. The system of claim 1 wherein the opaque plate 28 comprises a light transmitting plate having a coated portion 46 and an uncoated portion 48, the uncoated portion 48 forming the aperture 30.

7. The system of claim 1 wherein the opaque plate 28 has an absorbing layer.

8. The system of claim 6 wherein the absorbing layer is carbon black.

9. The system of claim 1 wherein the aperture 30 has a shape selected from the group consisting of rectangular, square, rounded rectangular, and stadium-shaped.

10. The system of claim 1 wherein the aperture 30 is sized to allow the incident laser beam and the reflected laser beam to pass through the aperture 30 without interference.

11. The system of claim 1 wherein the incident laser beam and the reflected laser beam define a travel region 32 within the aperture 30 and the aperture 30 is the size of the travel region 32.

12. The system of claim 1 wherein the incident laser beam and the reflected laser beam define a travel region 32 within the aperture 30 and the aperture 30 extends about 1 to 5 millimeters outside the travel region 32.

13. A method for reducing stray light in a Micromachined Electrical Mechanical System (MEMS) scanner comprising:
providing a MEMS mirror;
mounting an opaque plate having an aperture across from the MEMS mirror; and
directing an incident laser beam through the aperture onto the MEMS mirror to reflect from the MEMS mirror through the aperture as a reflected laser beam.

14. The method of claim 12 wherein the mounting comprises mounting an opaque plate at a non-zero mounting angle with respect to a MEMS mirror plane of the MEMS mirror.

15. The method of claim 12 further comprising blocking stray light from the MEMS mirror.

16. The method of claim 12 further comprising reducing reflection from the opaque plate.

17. A system for reducing stray light in a Micromachined Electrical Mechanical System (MEMS) scanner comprising:
a MEMS mirror;
means for mounting an opaque plate having an aperture across from the MEMS mirror; and
means for directing an incident laser beam through the aperture onto the MEMS mirror to reflect from the MEMS mirror through the aperture as a reflected laser beam.

18. The system of claim 16 wherein the means for mounting comprises means for mounting an opaque plate at a mounting angle with respect to a MEMS mirror plane of the MEMS mirror.

19. The system of claim 16 further comprising means for blocking stray light from the MEMS mirror.

20. The system of claim 16 further comprising means for reducing reflection from the opaque plate.
